(19) United States
(12) Patent Application Publication
(10) Pub. No.: US 2023/0066630 A1
(43) Pub. Date: Mar. 2, 2023

(54) SYSTEM AND METHOD FOR ENSURING DOCUMENT INTEGRITY WITH NON-FUNGIBLE TOKENS

(71) Applicant: Toshiba TEC Kabushiki Kaisha, Shinagawa-ku (JP)

(72) Inventor: John N. deWaide, Lake Forest, CA (US)

(21) Appl. No.: 17/410,076

(22) Filed: Aug. 24, 2021

(51) Int. Cl. G06Q 20/38; G06Q 20/36; G06Q 20/40; H04L 9/32

(52) U.S. Cl. CPC G06Q 20/38215; G06Q 20/367; G06Q 20/401; H04L 9/3213; G06Q 2220/00; H04L 2209/38

(57) ABSTRACT

A system and method for authenticating content or source of a transmitted electronic document includes a sender having a digital wallet. The sender uses their wallet and sends their document to non-fungible token network node to obtain a non-fungible token for their document. A unique non-fungible token is generated for the sender and document. The token is associated with the document and the combination sent back to the sender. The transaction is recorded in a blockchain of the non-fungible token network. The sender transmits their document via a network to a trusted recipient who was previously given access to the sender's digital wallet. Using the non-fungible token and digital wallet, the recipient browses the blockchain to confirm authenticity of their received document.

### TECHNICAL FIELD

This application relates generally to transmission of authenticatable electronic documents. The application relates more particularly to authentication of received electronic documents using non-fungible tokens.

### BACKGROUND

Electronic documents are routinely exchanged by networked digital devices such as workstations, servers, notebook computers, tablet computers and smartphones. Electronic files, such as electronic documents, multimedia files or image files may be transmitted between devices in a multiplicity of ways. These include network transmission or direct transmission. Network transmission can be accomplished with attachment of a file to an e-mail, via a file transfer protocol (FTP), via server storage or via cloud storage. Direct transmission can be accomplished with a wireless or wired link between devices. Wireless links may be radio frequency based, such as with Bluetooth, near field communication (NFC) or Wi-Fi direct. Wireless links may also be optical, such as with digitally pulsed light emitting diodes. Direct transmission may also use a physical transfer device, such as a USB drive or external hard drive.

Direct transmission is safe since there is little opportunity to intercept a document, alter a document or spoof a sender. Network transmissions can be risky, particularly if they involve sensitive or critical information. By way of example, a document requesting a digital funds transfer could include deposit account information for a thief, but appear to come from a legitimate requestor.

### BRIEF DESCRIPTION OF THE DRAWINGS

Various embodiments will become better understood with regard to the following description, appended claims and accompanying drawings wherein:

FIG. 1 is an example embodiment of a system for ensuring document integrity with non-fungible tokens;

FIG. 2 is a flowchart of a system for ensuring document integrity with non-fungible tokens;

FIG. 3 is an example embodiment of a digital device system;

FIG. 4 is a system overview of an example embodiment of a system for ensuring document integrity with non-fungible tokens;

FIG. 5 is a hardware block diagram of an example embodiment of a system for ensuring document integrity; and

FIG. 6 is a software block module diagram for an example embodiment of a system for ensuring document integrity with non-fungible tokens.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Given the problems with electronic documents transmitted via a network, it may be helpful to encrypt the document prior to transmission. Encryption may be accomplished, for example, with the use of public and private digital keys. Public key encryption, or public key cryptography, is a method of encrypting data with two different keys and making one of the keys, the public key, available for anyone to use. The other key is known as the private key. Data encrypted with the public key can only be decrypted with the private key, and data encrypted with the private key can only be decrypted with the public key. Public key encryption is also known as asymmetric encryption. Actual encryption may be accomplished with the use of hashing algorithm. Hashing algorithms are functions that generate a fixed-length result, known as a hash, or hash value, from a given input. The hash value is a summary of the original data.

A hash function algorithm is designed to be a one-way function, feasible to invert. However, in recent years several hashing algorithms have been compromised. This happened to MD5, for example, a widely known hash function designed to be a cryptographic hash function. MD5 encryption is now so easy to reverse, and therefor offers limited utility to verify data against unintentional corruption. A hashing algorithm alone is not tamper proof, and it may be relatively easy to spoof digital files to look like they are coming from a trusted source when they are not.

Proving the authenticity of digital documents is currently a very difficult task. There are many ways that a document may be falsely presented as genuine. One can make unlimited copies of files and even manipulate metadata manually to make a copy appear the same as the original file. For example, a sender's address can be spoofed, and a fake document with false information can be sent out by a malicious actor. It may be difficult, if not impossible, to determine whether a document is genuine.

Non fungible tokens (NFTs) provide a means of proving the authenticity of any kind of digital information that is representable as a file on a computer. An NFT is a unit of data stored on a digital ledger, called a blockchain, that certifies a digital asset to be unique and therefore not interchangeable. NFTs can be used to represent items such as photos, videos, audio, and other types of digital files. Access to any copy of the original file, however, is not restricted to a buyer or transferee of an NFT. While copies of these digital items are available for anyone to obtain, NFTs are tracked on blockchains to provide the owner with a proof of ownership that is separate from copyright.

Example embodiments herein prove authenticity of a document wherein an NFT is created and cryptographically tied to the document. Ownership of NFTs is associated with holding them in a public, digital wallet). By way of example, if a supervisor needs to know that a sensitive document you are sending is authentic, all they need to know is the public wallet address for the person who holds it. The NFT tied to the document can be verified as being held by that public wallet address. This acts as both proof of ownership and proof of document integrity.

Non-fungible tokens are somewhat analogous to more widely used cryptocurrency in that transactions involving NFTs are public knowledge on a blockchain. However, NFTs are non-fungible, meaning that every token is unique. Earlier implementations of NFTs were with distribution of digital art and collectibles. In example embodiments herein, NFTs are implemented to verify ownership and authenticity of a digital document. This can be useful in cases such as where sensitive documents being forged or misrepresented can be damaging to a company.

In example embodiments herein, a sender and recipient establish a mutual trust relationship wherein the recipient is made aware of the sender's public digital wallet address. Once they have the sender's public wallet address, they can browse a blockchain to ensure that a given NFT did in fact come from the sender.

Once a trust relationship has been established, the sender uploads a digital document on an NFT network, at which time an NFT will be generated and cryptographically associated with the file. Next, a blockchain is updated to represent that the person who uploaded the file is the owner. An NFT blockchain contains a perfect record of NFT ownership, both present and past.

When the document and associated NFT is sent and received, the recipient can verify on the public blockchain that the document is authentic. As long as the NFT is shown to be in possession of the sender, and that the recipient correctly knows the public wallet address of the sender, one can be assured that the document is authentic. Thus, use of a non-fungible token can prove authenticity of digital documents with the help of a public NFT blockchain.

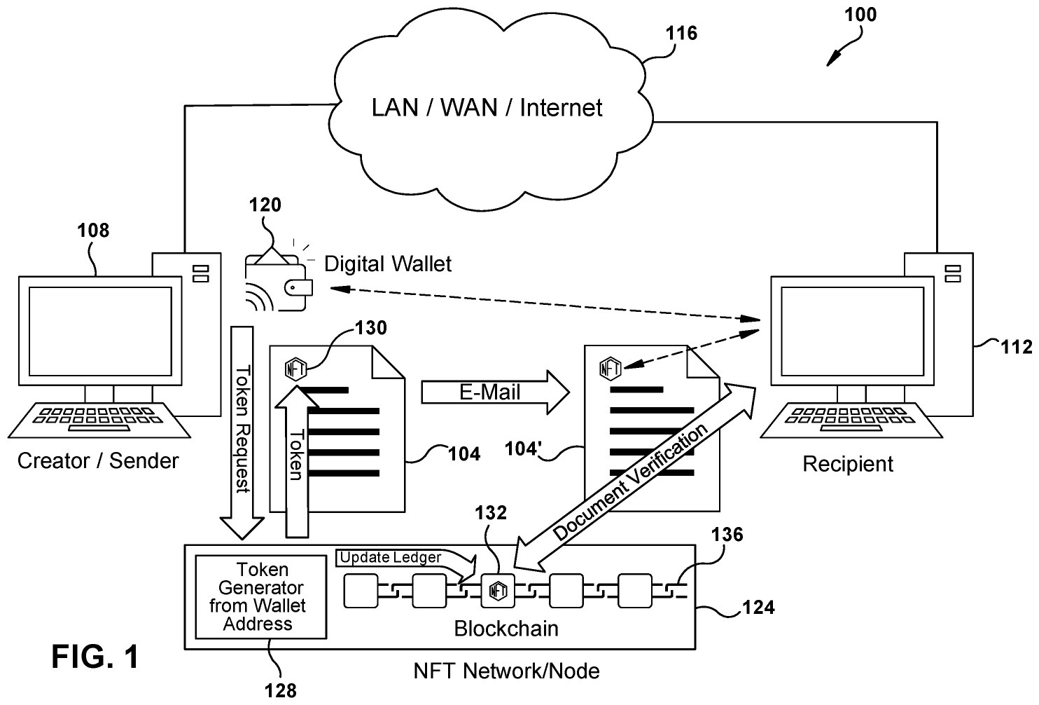

FIG. 1 illustrates an example embodiment of a system 100 for ensuring document integrity with non-fungible tokens. One or more electronic documents 104 are to be sent from sender device 108 to recipient device 112. While illustrated as workstations, devices 108 and 112 can be any suitable digital device, such as a notebook a computer, server, a tablet computer or a smartphone. Document transmission is via network cloud 116, suitably comprised of a local area network (LAN), a wide area network (WAN), which may comprise the Internet, or any suitable combination thereof. Network cloud is comprised of any suitable wireless or wired data connection or combination thereof.

A sender or sender device is associated with digital wallet 120 and sends electronic document 104 to any suitable node of NFT network 124. An NFT generator 128 creates a unique NFT 130 for the transaction, records it in block 132 of blockchain 136 and cryptographically associates it with electronic document 104 which is returned to the sender for transmission. When the NFT document is received as document 104′, a recipient using recipient device 112 accesses the digital wallet 120, and uses retrieved information to browse the blockchain 136. When block 132 is discovered, the recipient is assured that document 104′ is a true copy of electronic document 104, emanating from the sender associated with the sender device 108.

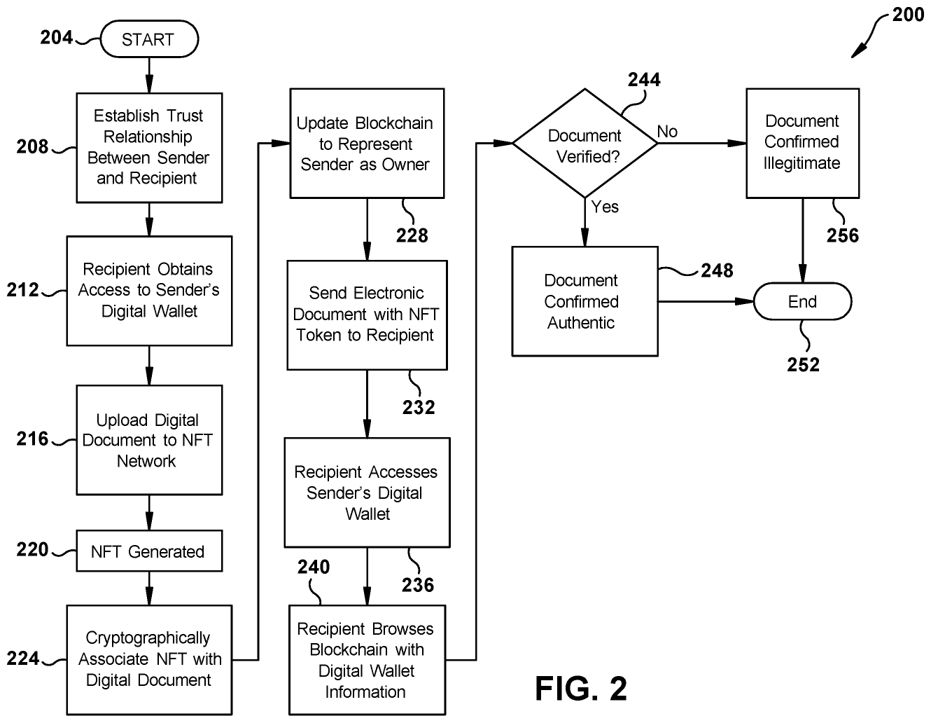

Turning now to FIG. 2, illustrated is a flowchart 200 of a system for ensuring document integrity with non-fungible tokens. The process commences at block 204 and proceeds to block 208 where a trust relationship is established between a sender and a recipient. The recipient obtains an address of the sender's digital wallet at block 212. The sender uploads their electronic document to an NFT network at block 216 at which a unique NFT is generated at block 220. The NFT is cryptographically associated with the document at block 224 and an NFT blockchain is updated with the transaction at block 228, representing the sender as owner of the document. The document with NFT is sent to the recipient at block 232.

The recipient receives the document and NFT, and accesses the sender's digital wallet at 236. Using the NFT and digital wallet, the recipient browses the blockchain at block 240 for the block associated with the document. If it is discovered and verified at block 244, the document is confirmed authentic at block 248 and the process ends at block 252. If the document is not verified at block 244, it is confirmed as illegitimate at block 256 before the process ends at block 252.

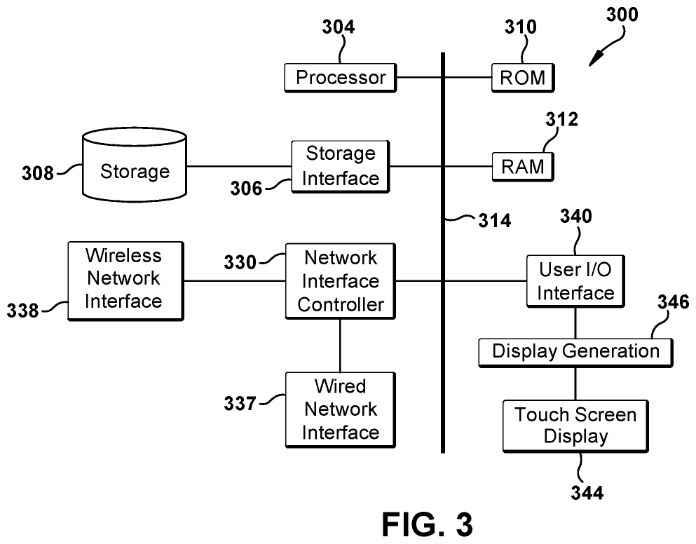

Turning now to FIG. 3, illustrated is an example embodiment of a digital data processing device 300 such devices 108 and 112 of FIG. 1. Components of the digital data processing device 300 suitably include one or more processors, illustrated by processor 304, memory, suitably comprised of read-only memory 310 and random access memory 312, and bulk or other non-volatile storage 308, suitably connected via a storage interface 306. A network interface controller 330 suitably provides a gateway for data communication with other devices, such as via wired network interface 337 or wireless network interface 338. A user input/output interface 340 suitably provides display generation 346 providing a user interface via touchscreen display 344, suitably displaying images from display generator 346. While a touchscreen is illustrated, any suitable user input and display can be used. It will be understood that the computational platform to realize the system as detailed further below is suitably implemented on any or all of devices as described above.

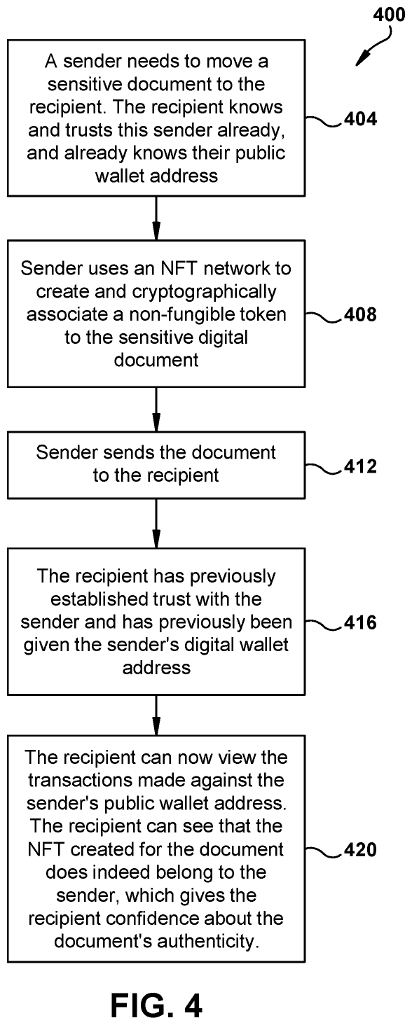

FIG. 4 is a system overview 400 of an example embodiment of a system for ensuring document integrity with non-fungible tokens. In block, 404, a sender wishes to send an electronic document to a trusted recipient who is already aware of an address of their public wallet. Next, in block 408, the sender secures an NFT from an NFT network for their document, and this NFT is cryptographically associated with the document. The document and associated NFT are sent the recipient at block 412. As noted by block 416, the sender has already been enabled to access the sender's digital wallet and such access facilitates validate the document at block 420.

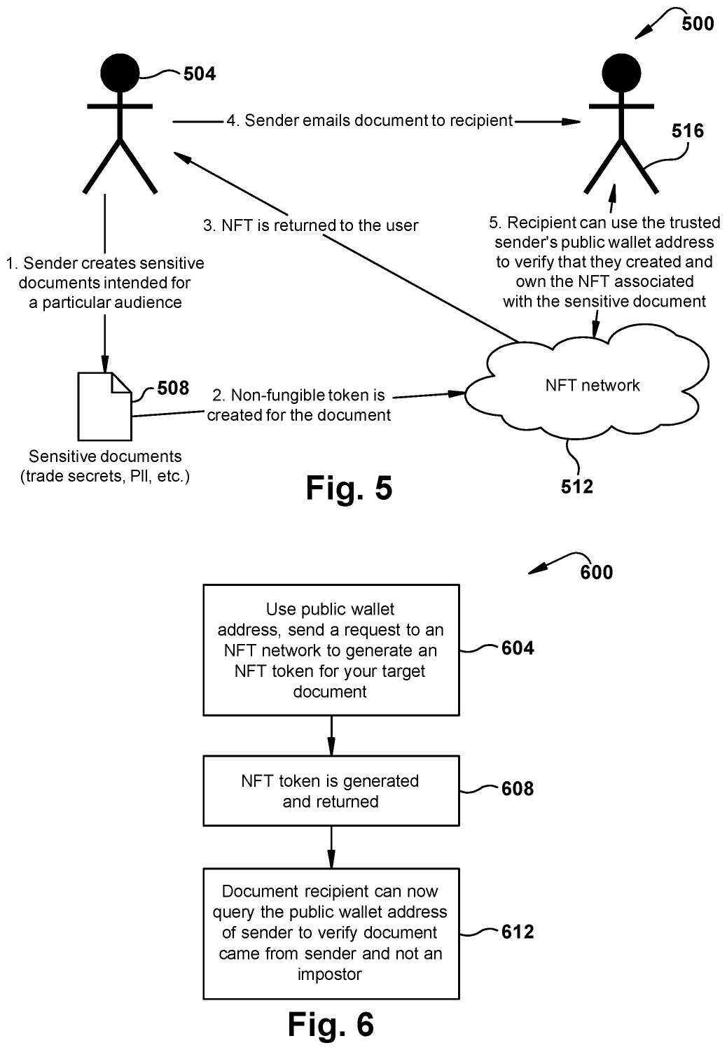

FIG. 5 is a hardware block diagram 500 of an example embodiment of a system for ensuring document integrity. Sender 504 creates document 508 which has sensitive information, such as trade secrets, personally identifiable information (PII), financial information or the like. The document is sent to NFT network 512 wherein a unique NFT is created and associated with the document before returning it to sender 504. Sender 504 sends the document and associated NFT to recipient 516 who uses the sender's digital wallet and NFT to browse a blockchain of NFT network 512 to verify authenticity and/or document source.

FIG. 6 is a software block module diagram 600 for an example embodiment of a system for ensuring document integrity with non-fungible tokens. In module 604, a public wallet address is used to request and NFT for a document. Module 608 generates a token, associates it with a document, updates a blockchain ledger and returns the document and associated NFT to the sender. In module 612, the document recipient queries the sender's public wallet to verify authenticity and/or source of the document in connection with the NFT.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
memory storing a digital wallet address for a digital wallet associated with a trusted user;
a network interface configured to receive an electronic document and an associated non-fungible token from a sender into the memory;
a processor configured to access the digital wallet via the network interface in accordance with the digital wallet address;
the processor further configured to browse a blockchain ledger in accordance with the associated non-fungible token and a query to the digital wallet at the digital wallet address; and
the processor further configured to determine whether the sender is the trusted user in accordance with the browse of the blockchain ledger.

2. The system of claim 1 wherein the processor is further configured to authenticate the electronic document when the processor determines that the sender is the trusted user.

3. The system of claim 2 wherein the digital wallet is a public.

4. The system of claim 2 wherein the associated non-fungible token is cryptographically associated with the electronic document.

5. The system of claim 2 wherein the processor accesses the blockchain ledger at a node of a non-fungible token network.

6. The system of claim 2 wherein the processor is further configured to receive the digital wallet address from the trusted user via the network interface.

7. A method comprising:
storing a digital wallet address for a digital wallet associated with a trusted user in memory;
receiving an electronic document and an associated non-fungible token from a sender into the memory via a network interface;
accessing the digital wallet via the network interface in accordance with the digital wallet address;
browsing a blockchain ledger in accordance with the associated non-fungible token and a query to the digital wallet at the digital wallet address; and
determining whether the sender is the trusted user in accordance with the browsing of the blockchain ledger.

8. The method of claim 7 further comprising authenticating the electronic document when a processor determines that the sender is the trusted user.

9. The method of claim 8 wherein the digital wallet is a public.

10. The method of claim 8 wherein the associated non-fungible token is cryptographically associated with the electronic document.

11. The method of claim 8 further comprising accessing the blockchain ledger at a node of a non-fungible token network.

12. The method of claim 8 further comprising receiving the digital wallet address from the trusted user via the network interface.

13. A system comprising:
a first processor;
a first memory storing an electronic document;
an identified digital wallet associated with an sending user accessible via a first network interface;
the first processor configured to generate a request for a non-fungible token corresponding to the identified digital wallet from an associated network server via the first network interface;
the first processor further configured to receive the non-fungible token into the first memory from the associated network server via the first network interface;
the first processor further configured to associate the electronic document with the received non-fungible token; and
the first processor further configured to send the electronic document and the associated non-fungible token to one or more recipient devices via the first network interface.

14. The system of claim 13 wherein the first processor is further configured to associate the electronic document with the non-fungible token cryptographically.

15. The system of claim 13 wherein the first processor is further configured to send a digital wallet address to the one or more recipient devices.

16. The system of claim 15 further comprising:
a second network interface configured to receive the digital wallet address into a second memory;
the second network interface further configured to receive the electronic document and associated non-fungible token from the first network interface into the second memory;
a second processor configured to access the identified digital wallet via the second network interface in accordance with the digital wallet address;
the second processor further configured to browse a blockchain ledger via the second network interface in accordance with the non-fungible token and a query to the identified digital wallet at the digital wallet address; and
the second processor further configured to authenticate the electronic document in accordance with the browse of the blockchain ledger.

17. The system of claim 16 wherein the first network interface comprises a node on a non-fungible token network.

18. The system of claim 17 wherein the blockchain ledger is stored on multiple nodes of the non-fungible token network.

19. The system of claim 18 wherein the identified digital wallet is associated with a trusted user and wherein the authenticated electronic document is confirmed to be associated with the trusted user.

20. The system of claim 19 wherein the request for the non-fungible token includes a copy of the electronic document.
